(19) United States
(12) Patent Application Publication
(10) Pub. No.: US 2026/0201721 A1
(43) Pub. Date: Jul. 16, 2026

(54) MOBILE PARASOL BASE ASSEMBLY

(71) Applicant: Po-Lung TUNG, Tainan City (TW)

(72) Inventor: Po-Lung TUNG, Tainan City (TW)

(21) Appl. No.: 19/018,902

(22) Filed: Jan. 13, 2025

(51) Int. Cl. E04H 12/22; B60B 33/06; F16M 11/10; F16M 11/42

(52) U.S. Cl. CPC E04H 12/2238; B60B 33/063; F16M 11/10; F16M 11/42; F16M 2200/024; F16M 2200/066

(57) ABSTRACT

A mobile parasol base assembly has a moving device, a driver, and a parasol base. The moving device has an underframe and multiple casters. The driver has an operating portion, an abutting portion, and a pivot portion pivotally connected to the underframe. The parasol base is disposed on and abutted by the abutting portion of the driver. The parasol base is pushed by the abutting portion to ascend when the driver pivots relative to the underframe by an external force acting on the operating portion, so the multiple casters protrude from the bottom end of the parasol base for the mobile parasol base assembly to move on the ground. The parasol base is also drivable by the gravity to descend and push the abutting portion downward, so the parasol base abuts the ground for positioning the mobile parasol base assembly.

### BACKGROUND OF THE INVENTION

### 1. Field of the Invention

The present invention relates to a parasol, and particularly to a mobile parasol base assembly.

### 2. Description of Related Art

A parasol is a large-scale umbrella often used as a sunshade or a rainshade at a fixed spot, e.g., in a backyard or at an outdoor seat of a shop. In the early days, a parasol base of the parasol may have different types such as a water-filled base, a sand-filled base, or a tripod base. All types of the parasol bases mentioned above allow the parasol to be positioned at a fixed point.

However, since the old parasol base described above is designed for positioning only, a position of the parasol with the old parasol base is difficult to be adjusted. Specifically, moving the old parasol base with a parasol body of the parasol can be laborious. For closing and detaching the parasol body from the old parasol base first and respectively moving the parasol body and the parasol base to a new position, the parasol body and the parasol base needs to be re-assembled, which can be troublesome. Thereby, the old parasol base is inconvenient in use.

To overcome the shortcomings of the old parasol base, the present invention tends to provide a mobile parasol base assembly to mitigate or obviate the aforementioned problems.

### SUMMARY OF THE INVENTION

The main objective of the present invention is to provide a mobile parasol base assembly which is convenient for moving and is also configured to be positioned at a fixed spot.

The mobile parasol base assembly has a moving device, a driver, and a parasol base. The moving device has an underframe and multiple casters disposed to the underframe. The driver has an operating portion, an abutting portion, and a pivot portion. The pivot portion is pivotally connected to the underframe and located between the operating portion and the abutting portion. The parasol base is disposed on and abutted by the abutting portion of the driver. When the driver pivots relative to the underframe by an external force acting on the operating portion, the abutting portion pushes the parasol base to ascend relative to the moving device, such that the multiple casters protrude from a bottom end of the parasol base. The parasol base is configured to press the abutting portion downward and descend relative to the moving device due to gravity.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a first preferred embodiment of a mobile parasol base assembly in accordance with the present invention;

FIGS. 2 and 3 are exploded views of the mobile parasol base assembly in FIG. 1;

FIG. 4 is an enlarged perspective view of a moving device and a driver of the mobile parasol base assembly in FIG. 1;

FIG. 5 is a perspective view of the driver in FIG. 4;

FIG. 6 is a side view of the mobile parasol base assembly in FIG. 1 omitting a positioning cap of a parasol base of the mobile parasol base assembly in FIG. 1;

FIG. 7 is a sectional side view of the mobile parasol base assembly in FIG. 1;

FIG. 8 and FIG. 9 are operational sectional side views of the mobile parasol base assembly in FIG. 1;

FIG. 10 is an operational side view of the mobile parasol base assembly in FIG. 6;

FIG. 11 is another operational sectional side view of the mobile parasol base assembly in FIG. 1;

FIG. 12 is a perspective view of a parasol applying the mobile parasol base assembly in FIG. 1;

FIG. 13 is an exploded view of a second preferred embodiment of the mobile parasol base assembly in accordance with the present invention; and

FIG. 14 is a sectional side view of the mobile parasol base assembly in FIG. 13.

### DETAILED DESCRIPTION OF THE PREFERRED EMBODIMENT

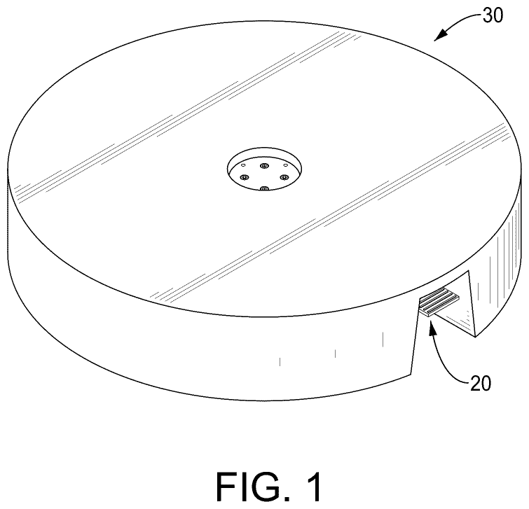

With reference to FIGS. 1 to 3, a first preferred embodiment of a mobile parasol base assembly in accordance with the present invention has a moving device 10, a driver 20, and a parasol base 30. The mobile parasol base assembly moves via the moving device 10. The driver 20 is disposed on the moving device 10. The parasol base 30 is placed on the driver 20.

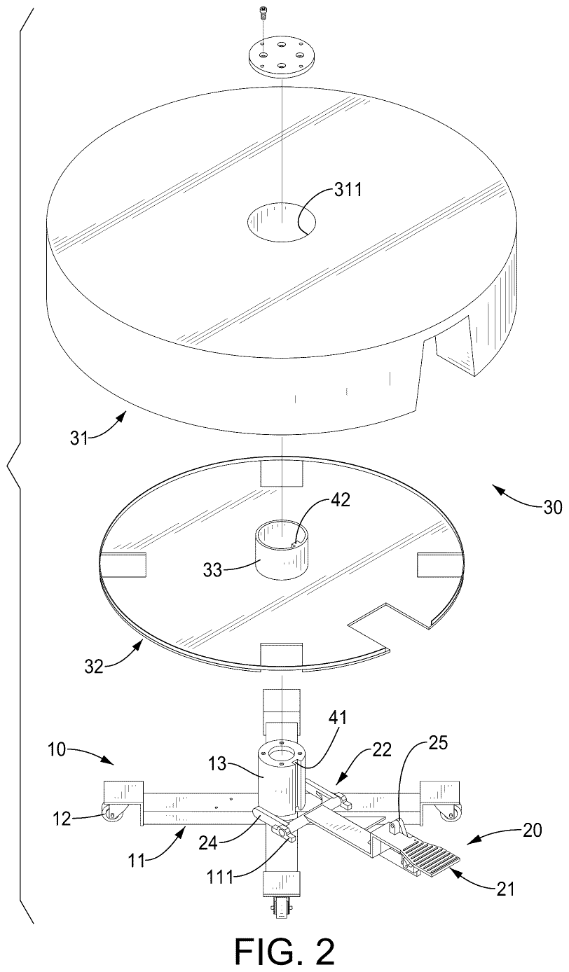

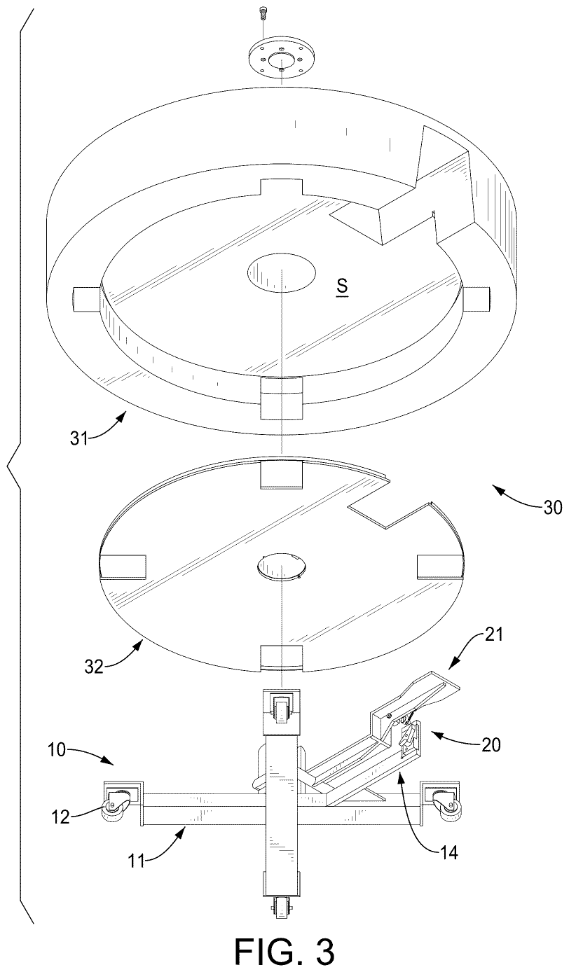

With reference to FIGS. 2 and 3, the moving device 10 has an underframe 11 and multiple casters 12. Specifically, the underframe 11 has a cross-shaped structure, and the moving device 10 has four said casters 12 respectively disposed to four end portions of the cross-shaped structure of the underframe 11. Each one of the multiple casters 12 has a mount and a wheel mounted to the mount. The mount of said casters is welded to the underframe 11. The moving device 10 is movable on the ground via the multiple casters 12.

With reference to FIGS. 2 to 5, the driver 20 has an operating portion 21, an abutting portion 22, and a pivot portion between the operating portion 21 and the abutting portion 22. The pivot portion is pivotally connected with the underframe 11. The operating portion 21 is configured for an external force to act thereon such that the driver 20 pivots about the pivot portion relative to the underframe 11.

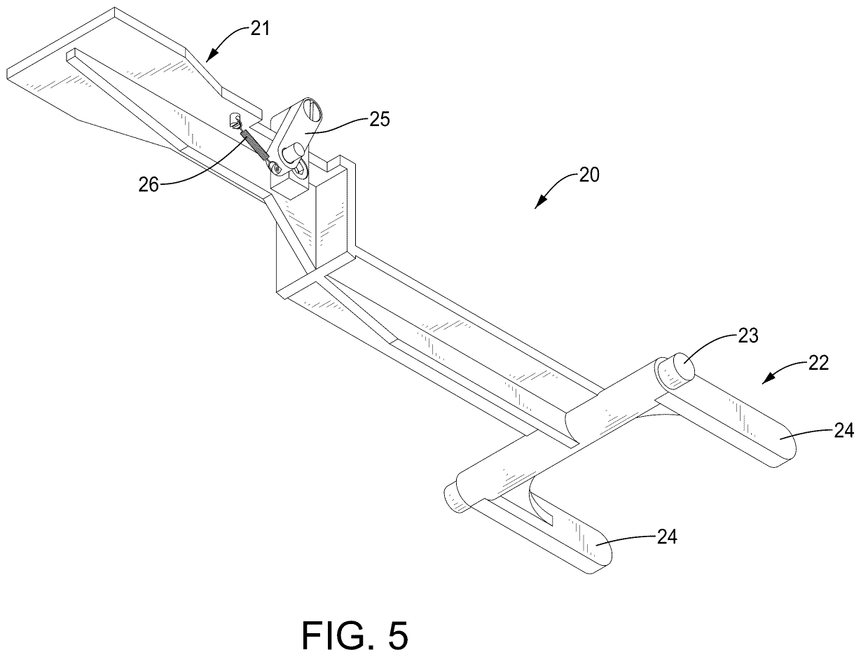

Specifically, with reference to FIG. 2, the underframe 11 has two pivot mounts 111, and with reference to FIG. 5, the pivot portion of the driver 20 is a pivot shaft 23. Each one of two opposite ends of the pivot shaft 23 is rotatably mounted to a respective one of the two pivot mounts 111. In addition, the operating portion 21 has a pedal structure for being stepped on to drive the driver 20 to pivot relative to the underframe 11, which improves convenience of operating the mobile parasol base assembly.

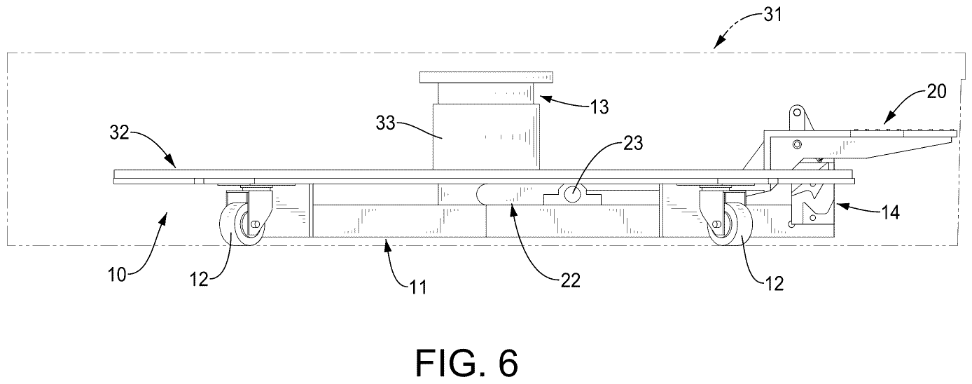

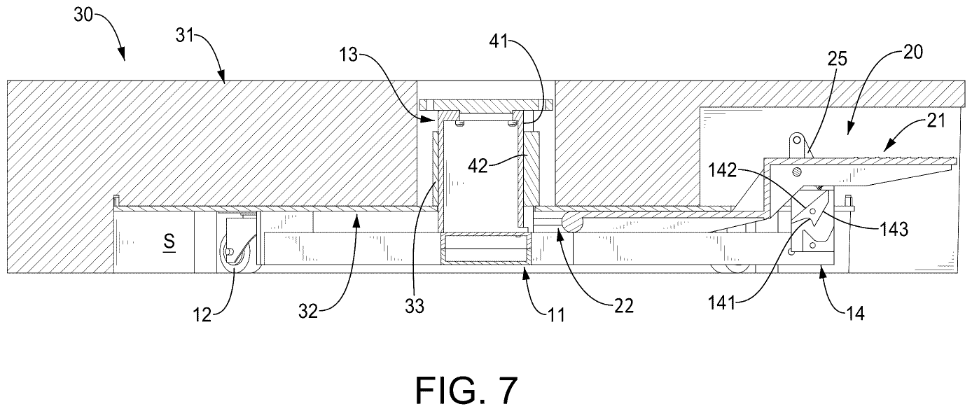

With reference to FIGS. 6 and 7, the parasol base 30 is disposed on and abutted by the abutting portion 22 of the driver 20. Thereby, when the driver 20 pivots relative to the underframe 11, the parasol base 30 is pushed by the abutting portion 22 of the driver 20 or driven by the gravity to ascend or descend, which changes a height position of the parasol base 30 relative to the multiple casters 12.

With reference to FIGS. 6 and 7, before operating the mobile parasol base assembly, the multiple casters 12 are retracted in the parasol base 30, and the mobile parasol base assembly abuts the ground via a bottom end of the parasol base 30. The mobile parasol base assembly is positioned at a fixed spot on the ground by frictional forces between the ground and the parasol base 30, being prevented from inadvertent movement due to any small external force.

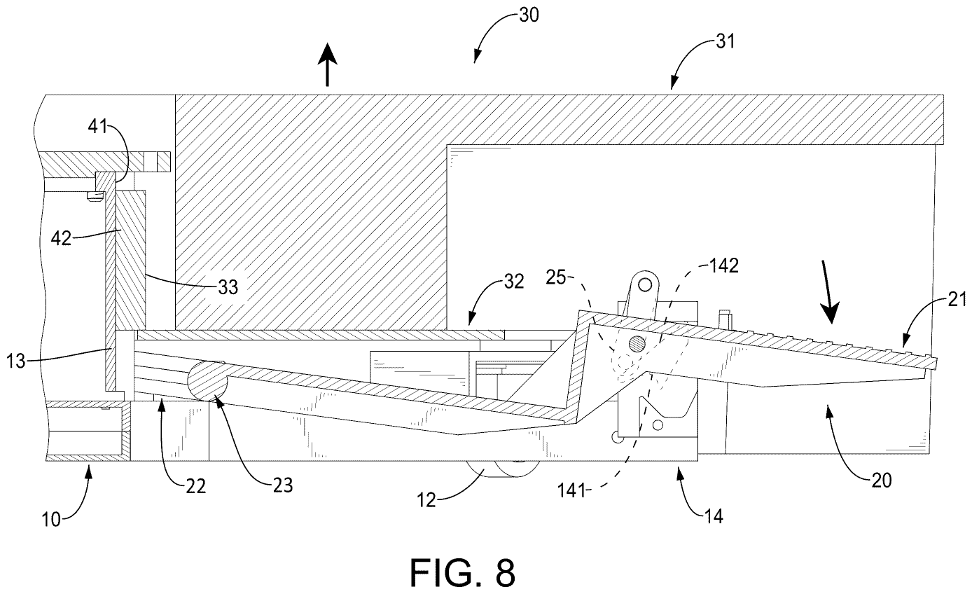

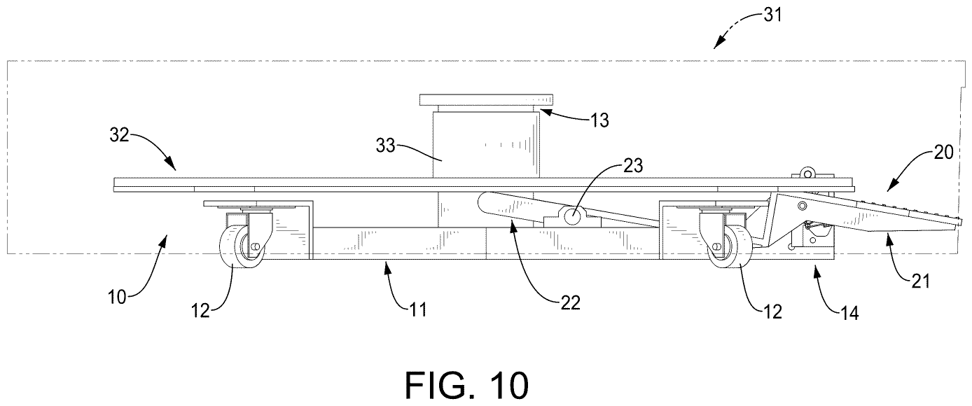

When trying to move the mobile parasol base assembly, with reference to FIGS. 8 to 10, the operating portion 21 is stepped on first for driving the driver 20 to pivot relative to the underframe 11. At the time, the abutting portion 22 swings and pushes the parasol base 30 upward. The parasol base 30 ascends relative to the moving device 10 such that the multiple casters 12 protrude from and are located below the bottom end of the parasol base 30. Thereby, the mobile parasol base assembly can move on the ground easily via the multiple casters 12.

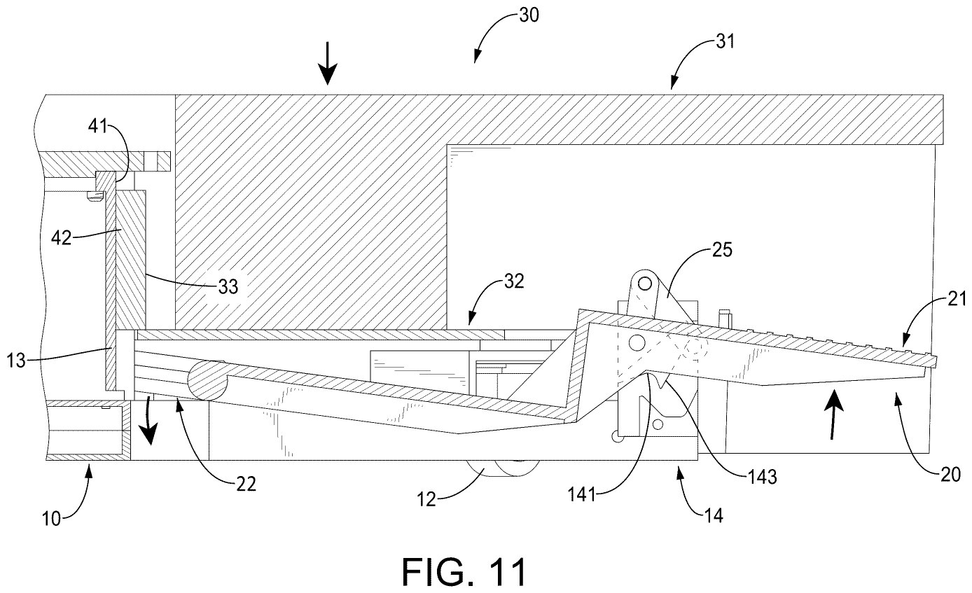

After the mobile parasol base assembly moves to an assigned spot, the mobile parasol base assembly needs to be re-positioned. With reference to FIG. 11, at the time, the operating portion 21 is released and no longer stepped on, and the parasol base 30 is driven by the gravity to descend relative to the moving device 10 and push the abutting portion 22 of the driver 20 downward. The driver 20 pivots backward until the abutting portion 22 is pushed downward onto the underframe 11. After the parasol base 30 descends, the multiple casters 12 are retracted in the parasol base 30 again and are flush with the bottom end of the parasol base 30. The bottom end of the parasol base 30 re-abuts the ground to position the mobile parasol base assembly at the assigned spot.

In the mobile parasol base assembly of the present invention, by the driver 20 driving the parasol base 30 to ascend, the multiple casters 12 protrude from the bottom end of the parasol base 30 and allow the mobile parasol base assembly to move on the ground easily. After moving, the parasol base 30 can descend due to the gravity so as to retract the multiple casters 12 therein. The mobile parasol base assembly can thus be positioned on the ground via the bottom end of the parasol base 30. Thereby, compared to the old parasol base designed for positioning only, the present invention provides the mobile parasol base assembly which is configured for both moving and positioning and improves convenience in use.

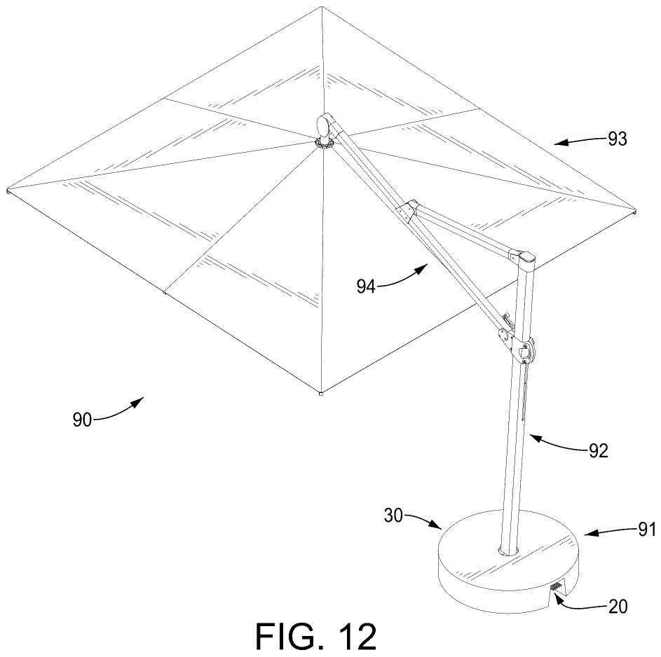

With reference to FIG. 12, in a specific application, the mobile parasol base assembly 91 is a component of a parasol 90, and the parasol 90 has a pole 92, a parasol body 93, and a support arm structure 94. The pole 92 is mounted through the parasol base 30 to be connected to the moving device 10. The parasol body 93 is disposed on the pole 92 via the support arm structure 94. By the mobile parasol base assembly 91, the parasol 90 is able to move, adjust its position, and be positioned after adjustment, which improves convenience in operation of the parasol 90.

Further, with reference to FIGS. 2, 3, 6, and 7, the moving device 10 has a post 13 disposed on the underframe 11. The parasol base 30 has a sleeve 33 slidably sheathed onto the post 13. When being pushed by the abutting portion 22 of the driver 20 to ascend or descending due to the gravity, the parasol base 30 stably moves along the post 13 without inadvertent deflection.

Specifically, the parasol base 30 has a positioning cap 31, an abutting disk 32, and the sleeve 33. The abutting disk 32 abuts on the abutting portion 22 of the driver 20. The positioning cap 31 abuts on the abutting disk 32 and has a through hole 311 for the post 13, the sleeve 33, and the pole 92 to be inserted therein. The sleeve 33 is connected to the abutting disk 32 and inserted in the through hole 311.

When the driver 20 pivots, the abutting portion 22 moves along a surface of the abutting disk 32 while pushing the abutting disk 32, which ensures pivoting of the driver 20 to be smooth. Besides, each one of the positioning cap 31 and the abutting disk 32 has multiple recesses or openings for the multiple casters 12 to enter or pass therethrough, which prevents interference between the multiple casters 12 and the parasol base 30. When positioning, the positioning cap 31 of the parasol base 30 abuts the ground.

Moreover, the mobile parasol base assembly has a limiting structure between the post 13 and the sleeve 33. The limiting structure has an elongated groove 41 and a rib 42. The elongated groove 41 and the rib 42 are respectively formed on the post 13 and the sleeve 33. In the first preferred embodiment, the elongated groove 41 is formed on the post 13 and extends to a bottom and a top of the post 13; the rib 42 is formed on the sleeve 33 and extends to a bottom and a top of the sleeve 33. The rib 42 is slidably disposed in the elongated groove 41 to provide a position-limiting efficacy. Thence, when the parasol base 30 ascends and descends relative to the moving device 10, the limiting structure limits relative rotation between the sleeve 33 and the post 13 to prevent the parasol base 30 from rotating and colliding with other components.

Besides, with reference to FIGS. 2 and 5, the abutting portion 22 of the driver 20 has two swing arms 24 spaced from each other. The post 13 is located between the two swing arms 24. When the abutting portion 22 swings upward, the two swing arms 24 push the abutting disk 32 respectively on two sides of the post 13 to drive the parasol base 30 to ascend, which improves stability of ascending.

With reference to FIGS. 2, 4, 6, and 7, in the first preferred embodiment, the moving device 10 has a positioning rack 14. The positioning rack 14 is fixed on the underframe 11 and has a positioning recess 141. The driver 20 has a positioning arm 25 for being engaged in the positioning recess 141 of the positioning rack 14. Specifically, the positioning arm 25 has a protrusion to be engaged in the positioning recess 141.

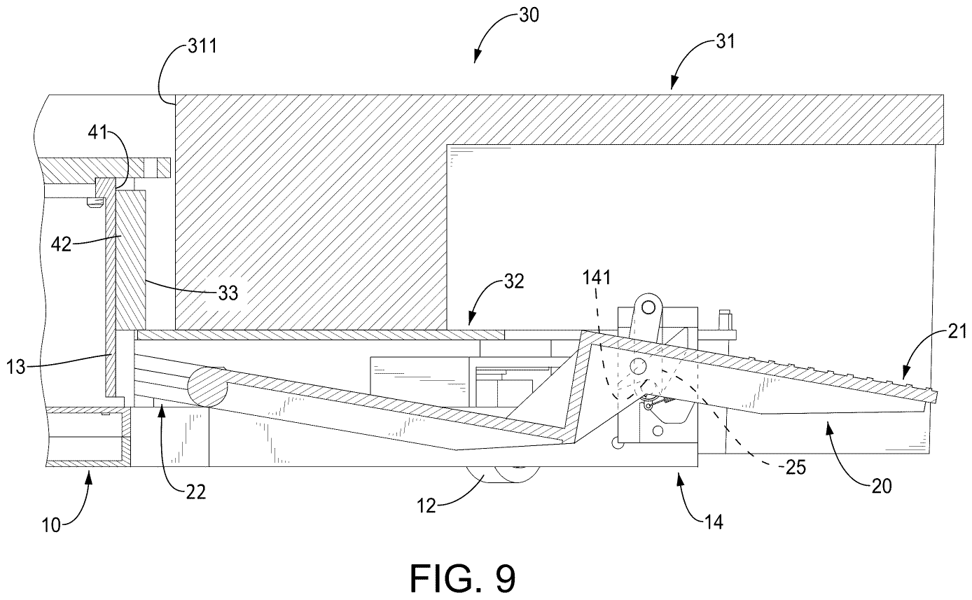

With reference to FIGS. 8 and 9, when the multiple casters 12 protrude from the bottom end of the parasol base 30 after the parasol base 30 ascends relative to the moving device 10, the positioning arm 25 is engaged in the positioning recess 141 as the driver 20 pivots, which positions the driver 20 and the parasol base 30 abutted by the abutting portion 22 of the driver 20 with respect to the positioning rack 14 and the underframe 11. Therefore, the multiple casters 12 are maintained outside the bottom end of the parasol base 30 for the mobile parasol base assembly to move. In other embodiments, if the mobile parasol base assembly omits the positioning recess 141 of the positioning rack 14 and the positioning arm 25 of the driver 20, the operating portion 21 needs to be stepped on continuously for moving the mobile parasol base assembly.

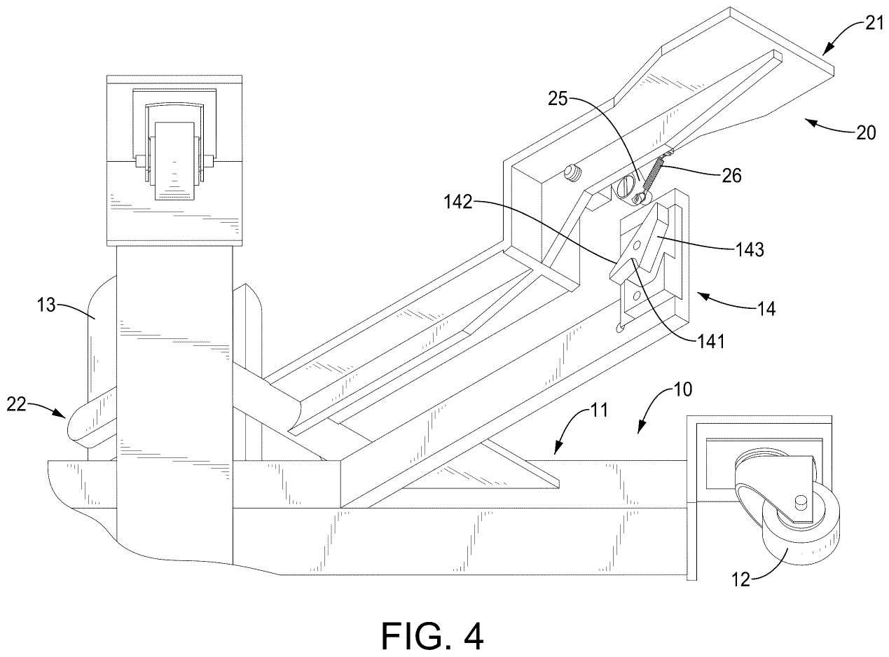

With reference to FIGS. 4 and 5, the positioning arm 25 is pivotally connected to the operating portion 21, and the driver 20 has a tension spring 26 connected between the operating portion 21 and the positioning arm 25. When contacting other components of the mobile parasol base assembly while the driver 20 pivots, the positioning arm 25 pivots relative to the operating portion 21 to prevent interference. The tension spring 26 limits a pivoting range of the positioning arm 25 and drives the positioning arm 25 to restore after pivoting, which ensures the positioning arm 25 to be engaged in the positioning recess 141 for positioning.

Preferably, with reference to FIGS. 4, 7, and 8, the positioning rack 14 has a guiding surface 142 connected to one of two opposite sides of the positioning recess 141. When the driver 20 pivots relative to the underframe 11 for driving the parasol base 30 to ascend, the positioning arm 25 first abuts the guiding surface 142. Then, the positioning arm 25 pivots relative to the operating portion 21 to slide along the guiding surface 142 to be engaged in the positioning recess 141. Thereby, the guiding surface 142 provides an efficacy of guiding.

After the positioning arm 25 is engaged in the positioning recess 141 to maintain the multiple casters 12 outside the parasol base 30, the multiple casters 12 need to be retracted for positioning the mobile parasol base assembly. With reference to FIG. 11, a user needs to step on the operating portion 21 again such that the positioning arm 25 departs from the positioning recess 141 as the driver 20 pivots. Afterwards, the operating portion 21 is released, and the parasol base 30 is driven by the gravity to descend and push the abutting portion 22 downward until the abutting portion 22 abuts the underframe 11.

Preferably, the positioning rack 14 has a cushion surface 143 connected to the other one of the two opposite sides of the positioning recess 141. When the positioning arm 25 departs from the positioning recess 141, the positioning arm 25 abuts and slides along the cushion surface 143. Thereby, when the operating portion 21 is released, the cushion surface 143 prevents the driver 20 from immediately returning to an original position due to a weight of the parasol base 30, which prevents shock and collision between the driver 20 and other components.

Specifically, the positioning rack 14 has a first protruding block and a second protruding block. The positioning recess 141, the guiding surface 142, and the cushion surface 143 are formed on a periphery of the first protruding block. The positioning recess 141 is recessed upward on the first protruding block. In a direction of a bottom end toward a top end of the mobile parasol base assembly, the guiding surface 142 and the cushion surface 143 obliquely extend from the two opposite sides of the positioning recess 141 respectively. The second protruding block is located below the positioning recess 141 and the cushion surface 143 for limiting a position of the positioning arm 25.

Additionally, with reference to FIGS. 3 and 7, in the first preferred embodiment, the parasol base 30 encloses and forms a containing space S therein for containing the moving device 10. The moving device 10 is contained in the containing space S as the parasol base 30 descends relative to the moving device 10 for positioning. Thereby, the parasol base 30 surrounds and covers the underframe 11, the multiple casters 12, and other structures of the moving device 10 to prevent users from being cut or pinched.

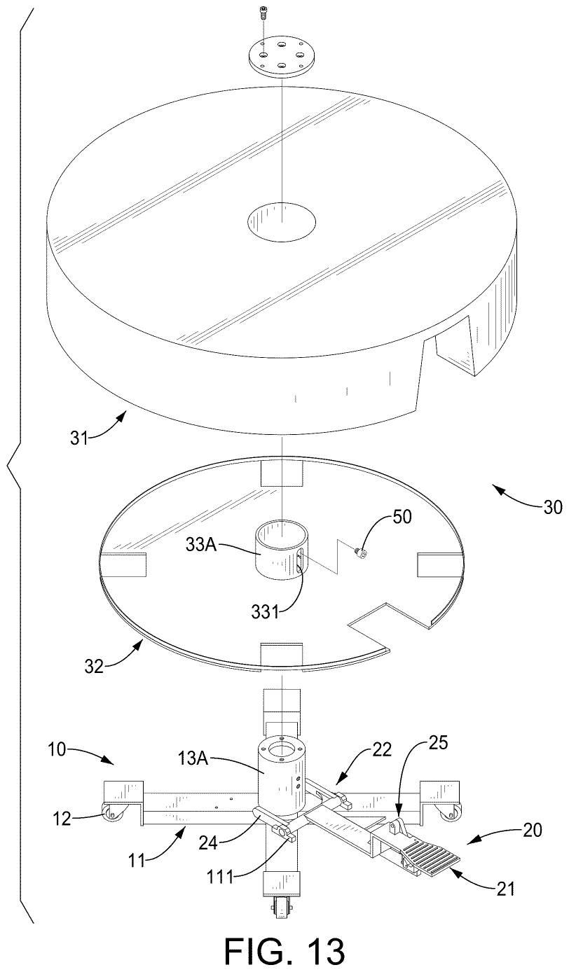

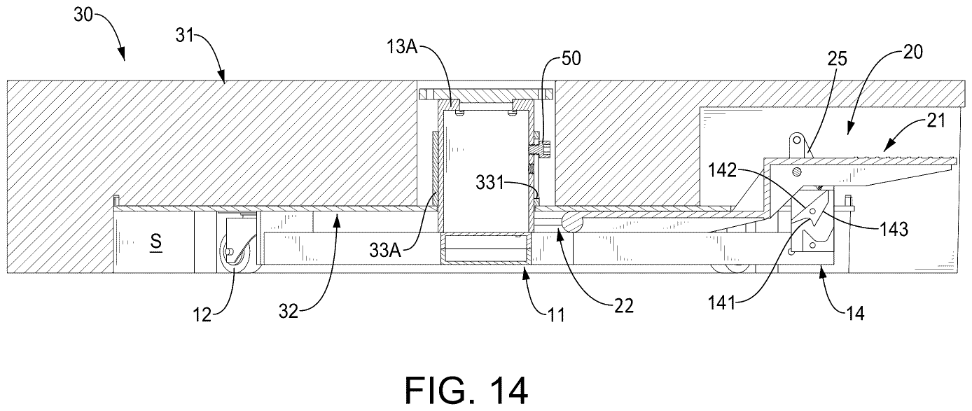

With reference to FIGS. 13 and 14, a second preferred embodiment of the mobile parasol base assembly in accordance with the present invention differs from the first preferred embodiment in configurations of the limiting structure between the post 13A and the sleeve 33A. In the second preferred embodiment, the sleeve 33A has an elongated hole 331 extending toward a top end and a bottom end of the sleeve 33A. The mobile parasol base assembly has a limiting unit 50 mounted through the elongated hole 331 and positioned on the post 13A. When the parasol base 30 ascends and descends relative to the moving device 10, the parasol base 30 moves relative to the moving device 10 and the limiting unit 50 via the elongated hole 331. Therefore, the limiting unit 50 limits relative rotation between the sleeve 33A and the post 13A such that the parasol base 30 is less likely to collide with other components of the mobile parasol base assembly.

Specifically, the limiting unit 50 is a bolt to be screwed to the post 13A for positioning. The post 13A has two threaded holes. The limiting unit 50 can be screwed into one of the two threaded holes according to sizes of the component of the parasol base 30 or a height of the post 13A to ensure that the bottom end of the parasol base 30 is flush with the casters 12 after descending. In other embodiments, the post 13A may have one or multiple threaded holes, or the limiting unit 50 may adopt a pin or other fastening unit to be mounted through the elongated hole 331 and fastened on the post 13A. All of the above-mentioned embodiments limit relative rotation between the sleeve 33A and the post 13A. Configurations of the limiting unit 50 and the post 13A are not limited to the second preferred embodiment.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A mobile parasol base assembly comprising:
a moving device having
an underframe; and
multiple casters disposed to the underframe;
a driver having
an operating portion;
an abutting portion; and
a pivot portion pivotally connected to the underframe and located between the operating portion and the abutting portion; and
a parasol base disposed on and abutted by the abutting portion of the driver;
wherein
when the driver pivots relative to the underframe by an external force acting on the operating portion, the abutting portion pushes the parasol base to ascend relative to the moving device, such that the multiple casters protrude from a bottom end of the parasol base; and
the parasol base is configured to press the abutting portion downward and descend relative to the moving device due to gravity.

2. The mobile parasol base assembly as claimed in claim 1, wherein
the moving device has a post disposed on the underframe; and
the parasol base has a sleeve slidably sheathed onto the post of the moving device such that the parasol base ascends and descends along the post.

3. The mobile parasol base assembly as claimed in claim 2, wherein
the sleeve of the parasol base has an elongated hole extending toward a top end and a bottom end of the sleeve; and
the mobile parasol base assembly comprises a limiting pin mounted through the elongated hole and positioned on the post to limit relative rotation between the sleeve and the post.

4. The mobile parasol base assembly as claimed in claim 2, wherein
the mobile parasol base assembly comprises a limiting structure having a rib and an elongated groove respectively formed on the post and the sleeve; and
the rib is slidably disposed in the elongated groove to limit relative rotation between the sleeve and the post.

5. The mobile parasol base assembly as claimed in claim 2, wherein
the abutting portion has two swing arms spaced from each other; and
the post of the moving device is located between the two swing arms.

6. The mobile parasol base assembly as claimed in claim 1, wherein
the moving device has a positioning rack disposed on the underframe and having a positioning recess;
the driver has a positioning arm; and
when the multiple casters protrude from the bottom end of the parasol base, the positioning arm is engaged in the positioning recess to fix the driver and the parasol base with respect to the moving device.

7. The mobile parasol base assembly as claimed in claim 6, wherein
the positioning arm is pivotally connected to the operating portion of the driver; and
the driver has a tension spring connected between the operating portion and the positioning arm.

8. The mobile parasol base assembly as claimed in claim 7, wherein
the positioning rack has a guiding surface being inclined and connected to one of two opposite sides of the positioning recess; and
the positioning arm is configured to move along the guiding surface to be engaged in the positioning recess.

9. The mobile parasol base assembly as claimed in claim 7, wherein
the positioning rack has a cushion surface being inclined;
the positioning arm is configured to depart from the positioning recess to move along the cushion surface.

10. The mobile parasol base assembly as claimed in claim 1, wherein the parasol base has a containing space formed therein for containing the moving device.

11. The mobile parasol base assembly as claimed in claim 2, wherein the parasol base has a containing space formed therein for containing the moving device.

12. The mobile parasol base assembly as claimed in claim 3, wherein the parasol base has a containing space formed therein for containing the moving device.

13. The mobile parasol base assembly as claimed in claim 4, wherein the parasol base has a containing space formed therein for containing the moving device.

14. The mobile parasol base assembly as claimed in claim 5, wherein the parasol base has a containing space formed therein for containing the moving device.

15. The mobile parasol base assembly as claimed in claim 6, wherein the parasol base has a containing space formed therein for containing the moving device.

16. The mobile parasol base assembly as claimed in claim 7, wherein the parasol base has a containing space formed therein for containing the moving device.

17. The mobile parasol base assembly as claimed in claim 8, wherein the parasol base has a containing space formed therein for containing the moving device.

18. The mobile parasol base assembly as claimed in claim 9, wherein the parasol base has a containing space formed therein for containing the moving device.
